(19) United States
(12) Patent Application Publication
(10) Pub. No.: US 2009/0287759 A1
(43) Pub. Date: Nov. 19, 2009

(54) SYSTEM AND METHOD FOR PROVIDING IMAGING OPERATIONS IN MULTIPLE ENVIRONMENTS

(76) Inventor: David R. Wilson, Hickory Creek, TX (US)

Correspondence Address: Patent Capital Group, 6119 McCommas Blvd, Dallas, TX, 75214, US

(21) Appl. No.: 12/121,970

(22) Filed: May 16, 2008

(51) Int. Cl. G06F 15/16

(52) U.S. Cl. 709/201

(57) ABSTRACT

According to a particular embodiment, an imaging system is provided that includes an imaging device operable to image a hard-drive of a target device. The imaging device includes a first connection to the target device and a second connection to an output capture device, whereby both connections facilitate an information flow of data. The imaging device includes a network connectivity element that allows the imaging device to be connected to a network, the network connection facilitating communications between a computing device being controlled by an administrator and the imaging device such that that administrator controls some operations of the imaging device from his computing device.

### TECHNICAL FIELD OF THE INVENTION

The present invention relates generally to imaging activities involving hard-drives and, more particularly, to a system and a method for providing more efficient imaging operations in different data collection environments.

### RELATED APPLICATION

This application is related to a second application, filed on the same date as this case, having the same sole inventor, and entitled: “SYSTEM AND METHOD FOR PROVIDING PREPROGRAMMED IMAGING IN A DATA COLLECTION ENVIRONMENT.”

### BACKGROUND OF THE INVENTION

Due to growing litigation, huge damage awards from jury verdicts, and heightened data security awareness, the importance of computer forensics has grown exponentially in recent years. Computer forensics is a branch of forensic science pertaining to legal evidence found in computers and digital storage mediums. Electronic evidence can be collected from a variety of sources. Computer forensics experts can investigate data storage devices, such as hard-drives, USB Drives, CD-ROMs, floppy disks, and tape drives. The integrity of this imaged data can be crucial because typical computer forensics adheres to standards of evidence admissible in a court of law.

The process of creating an exact duplicate of an original hard-drive is not without its problems. One type of early imaging protocol revolved around the concept of simply using software on a desktop computer, but these techniques were challenging to implement. A second type of protocol for making exact copies of long-term memory storage devices involves the use of dedicated stand-alone devices. Logicube (of Chatsworth, Calif.) manufactures and distributes such devices. These devices have numerous operating modes and options that must be specified before making a copy of a hard-drive. Options are selected through the use of a number of buttons and a small display.

These stand-alone devices have several limitations. For example, these devices generally include a cavity or recess where a targeted hard-drive is placed while operations are being performed. As high-speed imaging is occurring and as one continuous stream of data is collected, the targeted hard-drive will heat up. Thus, enclosing a hard-drive in another device (for data capture purposes) only worsens this problem. Where temperatures reach a certain level, the imaging process will fail. To attenuate this heating issue, a number of manufacturers have elected to include a fan in these devices. While theoretically well-conceived, this solution has not solved this heating problem.

Another issue with these stand-alone devices is that they require constant attention from a forensic expert. More directly, these devices necessitate an operator to virtually hover over these devices as they run through their image-collecting activities. Moreover, because the devices require a constant operator presence, they can never be effectively deployed without also deploying a forensic expert that accompanies them.

Accordingly, the ability to provide a flexible, intelligent mechanism for making exact copies of long-term memory storage devices offers a significant challenge to forensic data experts and manufacturers alike.

### SUMMARY OF THE INVENTION

In accordance with certain embodiments of the present invention, techniques for supporting an ideal imaging system are provided that substantially eliminate or effectively reduce problems and deficiencies of other imaging solutions.

According to a particular embodiment, an imaging system is provided that includes an imaging device operable to image a hard-drive of a target device. The imaging device includes a first connection to the target device and a second connection to an output capture device, whereby both connections facilitate an information flow of data. The imaging device includes a network connectivity element that allows the imaging device to be connected to a network, the network connection facilitating communications between a computing device being controlled by an administrator and the imaging device such that that administrator controls some operations of the imaging device from his computing device.

In more particular embodiments, the imaging device includes a targeted search engine that allows the imaging device to perform targeted searches on the hard-drive. The imaging device also includes a logging element that generates a log of activities performed by the imaging device. Additionally, the imaging device encrypts data as it captures it. In yet other embodiments, the imaging device includes a diagnostic element that performs an error check for operations performed by the imaging device. The imaging device can also include a processor that executes hashing operations for data being collected by the imaging device.

In more detailed embodiments, the network can be a LAN, a Wi-Fi network, a WLAN, a WAN, a MAN, an Edge Network, or a hot spot. The imaging device can also include a VPN connect element that offers a web-enabled over-VPN connect capability to control the imaging device by the administrator. When in a VPN mode, the administrator can perform a selected one of running searches, creating images, generating reports, performing targeted collections, and browsing the hard-drive.

In still other examples, the imaging device includes software that tracks a copy status for the hard-drive during imaging operations. The imaging device can also include a light and a speaker: both of which can indicate some form of status for the imaging device. There are a plethora of additional capabilities for the imaging device [and its accompanying software] and those are best understood with reference to the FIGURES that follow.

Embodiments of the invention provide various technical advantages. Other technical advantages of the present invention will be readily apparent to one skilled in the art from the following figures, descriptions, and claims. Moreover, while specific advantages have been enumerated herein, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a block diagram that illustrates a system for imaging data in accordance with one embodiment of the present invention;

FIG. 2 is a simplified schematic diagram of a device to be used in imaging data in the system;

FIG. 3 is a simplified block diagram that offers an example arrangement for the device to be used in imaging data;

FIGS. 4A-4C are simplified process flows for depicting example protocols to be used in conjunction with the device; and

FIGS. 5A-5B are additional process flows that illustrate how the device can be used for imaging in a common ‘local network’ paradigm.

### DETAILED DESCRIPTION OF THE INVENTION

Note that for purposes of teaching and discussion, it is useful to provide some background overview as to the way in which the tendered invention operates. The following foundational information describes some of the problems/arrangements that may be solved/addressed by the present invention. This general information may be viewed as a basis from which the present invention may be properly explained. Such information is offered earnestly for purposes of explanation only and, accordingly, should not be construed in any way to limit the broad scope of the present invention and its potential applications.

When a forensic consultant typically arrives at a customer location, there are a series of target hard-drives, which may reside in laptops, desktops, etc. Generally, an imaging project implicates some portable device (such as those manufactured by Logicube), where the device is hooked up to the target hard-drive, parameters are set on the outside panel of the device, and the cloning or imaging operation is triggered. This can be thought of as a standalone device. Routinely, there are some final hashing activities that occur to ensure a comprehensive image of the entire hard-drive.

These devices have a number of shortcomings (overheating, slow collection times, an inability to be managed remotely, an inability to be autonomous, an inability to solicit an end user with end-user prompting, a lack of network capabilities, etc.). Consider an example in which a forensic data expert, who is based in Dallas, Tex., receives an urgent call from a client in Chicago. The client in this instance needs the forensic data expert to come out and image a single hard-drive, which is the target of some type of investigation or litigation matter.

If this target hard-drive were local, the service fee for such an operation would be minimal. The time to image an average-sized hard-drive is about 1-2 hours. However, just based on a RUSH travel itinerary, this simple task could morph into a $3,000 bill for the Chicago client. The majority of this fee is simply travel expenses.

In another scenario, a local site may include twenty desktops to be imaged by the forensic expert. While it is true that having five or six of these standalone units would allow the forensic expert team to image five computers concurrently, there are still gross inefficiencies with this model. For example, this scenario engenders an assembly line model, where the forensic expert team must keep track of each hard-drive and which desktop is associated with each hard-drive. (Note: Bar-coding is generally done to ensure accuracy in these scenarios.)

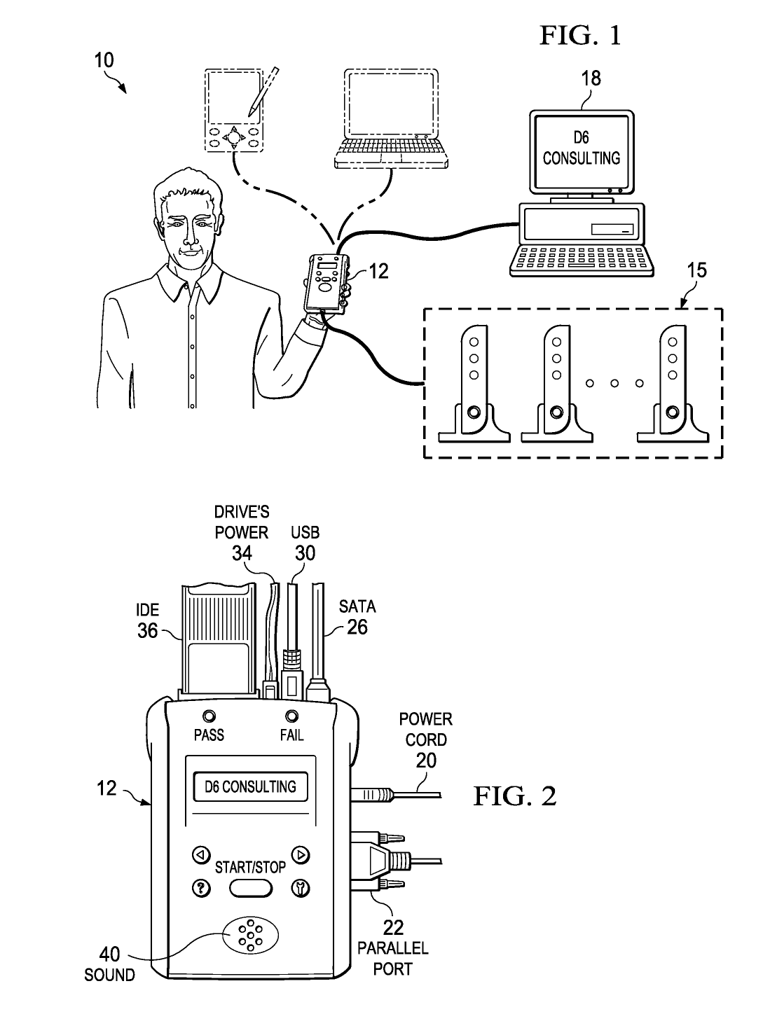

The present invention overcomes these shortcomings, and others, in providing the ability to optimally manage one or a set of devices 12. FIG. 1 illustrates a general data collection system 10, which includes device 12, a set of capture output devices 15, and a set of target devices 18. One preferred method of capture (output) will be to a SATA hard drive. However, device 12 has the capability to output to a PATA drive, or any other suitable end destination. Target devices 18 can include any suitable element that has some information that is sought to be copied, replicated, harvested, or transferred: either in part or fully. In this example scenario, a laptop, a PDA, and a simple desktop computer are illustrated as being the potential target devices. Any other suitable device that includes data to be managed could certainly benefit from the teachings of the present invention.

In operation, there are essentially three protocols for acquiring the data from a target hard-drive. Importantly, all three of these outlined protocols do not compromise the integrity of the data, as each creates a perfect digital fingerprint of the data sought to be imaged or cloned. The first protocol involves a preprogramming mode of device 12, where device 12 autonomously collects data after being powered ON and activated.

The second protocol (also referred to as a ‘local network’ model as used herein in this document) involves the implementing of an ad-hoc network with wireless capabilities for devices 12. In essence, the administrator has created a mini wireless network, where data can be encrypted (such that it will not be compromised by unauthorized 3^{rd} parties). Consider a case where a sophisticated company is resistant to a forensic data expert plugging their equipment into their company's network. Typically, there are a number of IT checks or validations that need to occur before an ‘outside’ device would be authorized to connect to the company's network. This second protocol would solve these issues in providing an effective response to such a scenario.

The third protocol is a pure network-based approach. This protocol may be viewed as an ‘enterprise’ and ‘VPN’ solution. (As used herein in this document, these terms are interchangeable.) This third protocol would allow device 12 to connect anywhere in the world, over the Internet (e.g., leveraging a dial-up connection, satellite connection, etc.). It should be noted that device 12 (under any of these protocols) can operate with the hard-drive being in-situ (i.e. remaining in the targeted machine) or it can collect information through various cable and wire systems, where the hard-drive is first removed from the target device and then connected to device 12. The choice as to which option to select can be based on specific needs, or individual circumstances of a given imaging job.

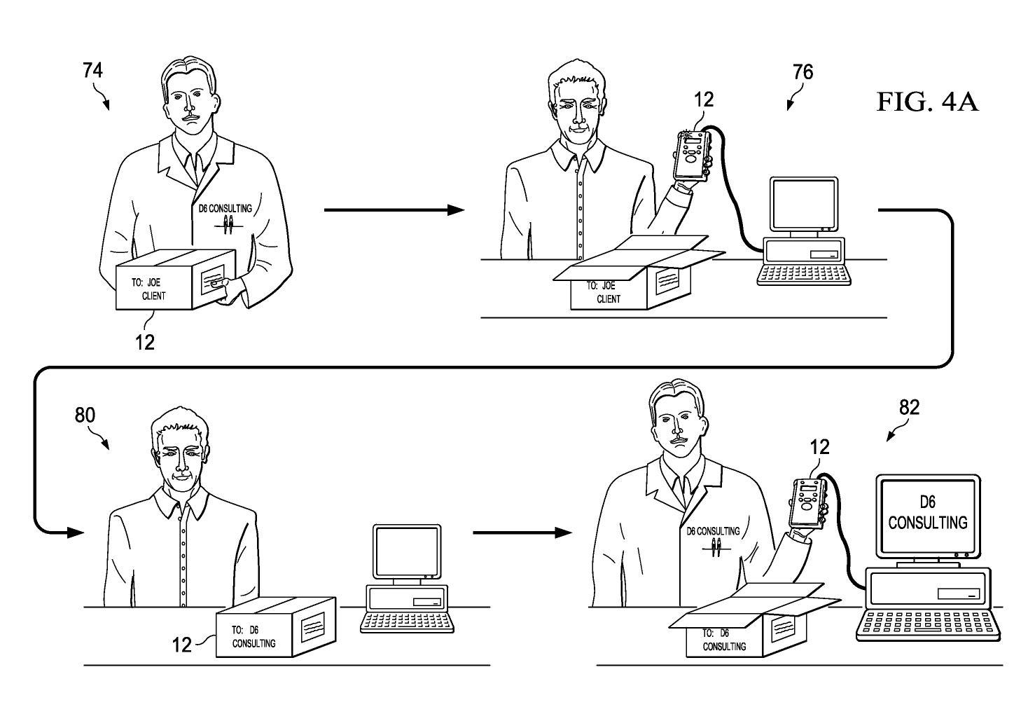

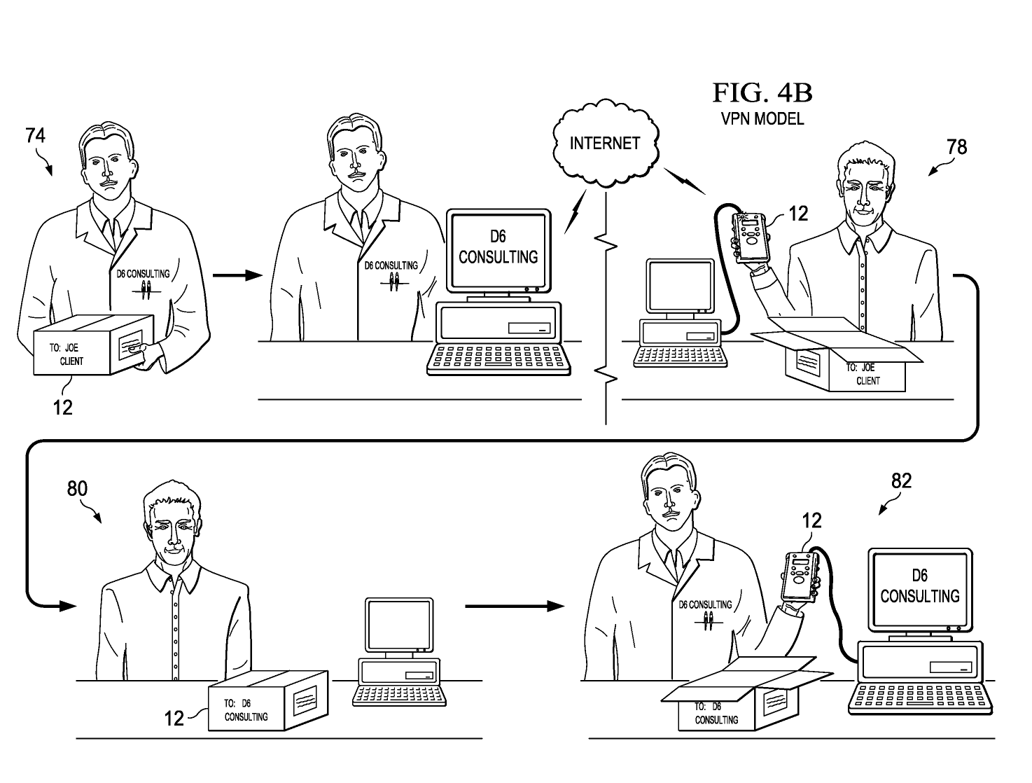

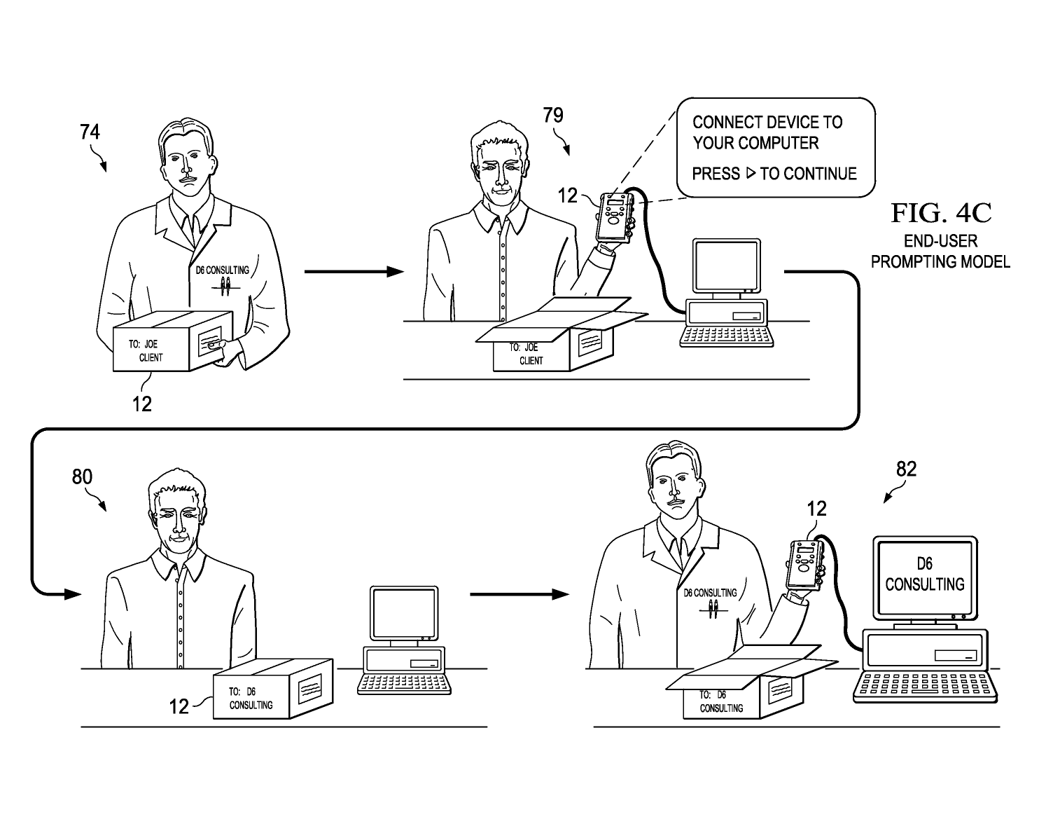

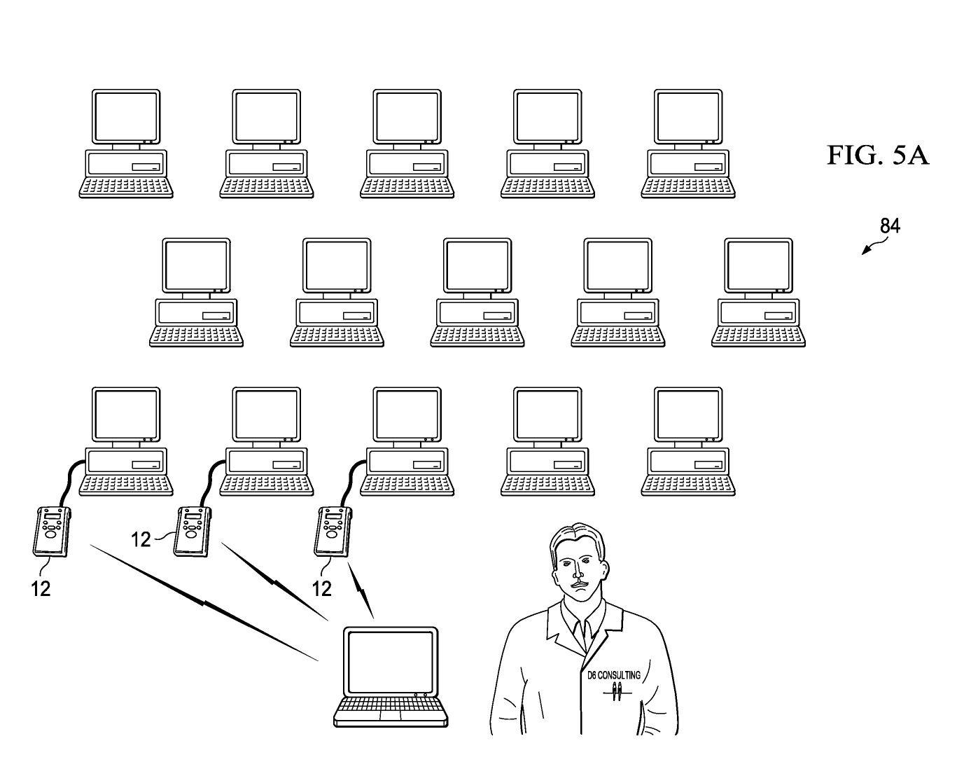

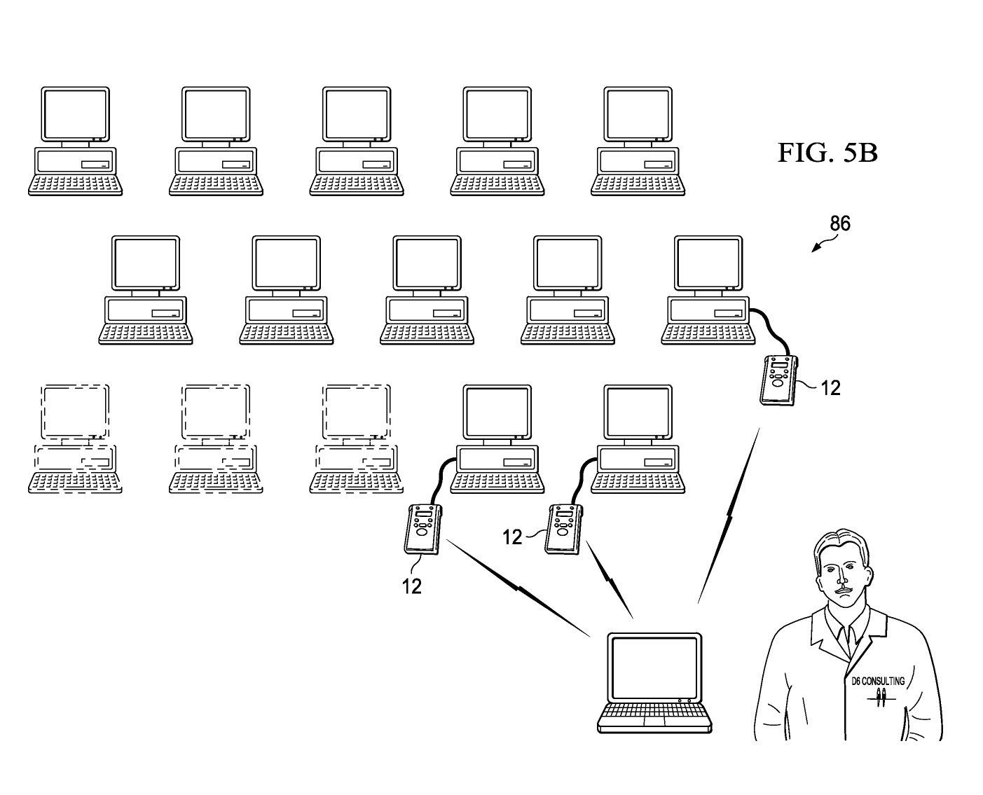

Note that each of these three protocols identified above is further detailed below with respect to specific FIGURES and process flows that better inform the audience of the capabilities of device 12. The preprogrammed and Enterprise/VPN models (options one and three respectively) are described with reference to FIGS. 4A-4C. The network model (option two) is described with reference to FIGS. 5A-5B and this network model is the most common.

Hence, in essence, there are two avenues of control for device 12. One control avenue is simply the preprogramming mode where device 12 already understands how it is to behave. The second control avenue allows a forensic data expert (an authorized administrator of device 12) to control the operations of device 12: either through a ‘local network’ protocol (which is typically the most common) or through a VPN/Enterprise protocol. Again, all of these protocols are further described below with reference to corresponding FIGURES.

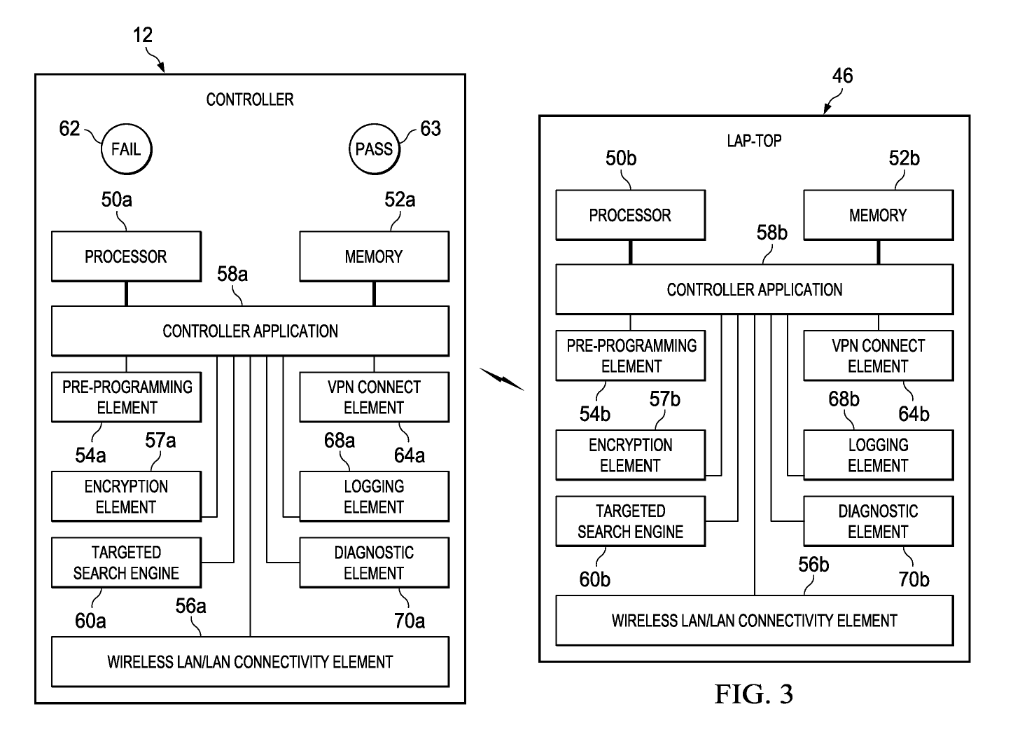

Turning now to the inherent structure of the unit, device 12 is a portable computing element that will copy the contents from any data storage unit to another data storage unit with specific file and formatting instructions. The formatting instructions can be remotely controlled by a computer that has been given the authority to guide the activities of device 12. Generally, the controller application (as further detailed in FIG. 3 below) resides within each handheld device 12.

Note that a brief overview of device 12 is provided here; however more specific details about these capabilities and the activities described are discussed below with reference to additional FIGURES. This abbreviated overview can be viewed as a simple outline, while additional features and significant ancillary activities are further explained below. System 10 can include device 12, which connects to the target drive 18 and a destination drive (output device 15). Device 12 can readily support SATA or PATA drives, where external adapters are not necessarily determinative as to whether SATA or PATA drives are employed. In certain embodiments, universal connectors or separate connectors and dedicated units may be used in conjunction with device 12.

Device 12 can easily connect to a wireless LAN or a LAN infrastructure, which allows device 12 to be used in ‘Enterprise’ and ‘Local Network’ protocols, as explained below with reference to example flows that better guide the audience. A remotely controlled device 12 can be manipulated by a forensic expert using a simple computer that is running the controller application. This computer being used by the forensic expert can be connected to a Wireless LAN, WAN, MAN, or LAN.

In one non-limiting example, the physical size of device 12 is approximately 13×20 cm (5″×8″), but could certainly be constructed to be larger or smaller based on particular needs. Device 12 can copy at approximately 2.5 GB per-minute based on one example processing power; however other processors (having alternative processing speeds) could readily be implemented in device 12 without departing from the teachings of the present invention. Device 12 can include a simple LCD screen with appropriate error/success messages, or simple prompts for an end user to follow.

FIG. 2 is another example schematic diagram of device 12. In this example, there are a number of plugs on the perimeter of device 12 such that it can be connected to other components, as needed. Other embodiments of device 12 could include some, all, or none of these connection capabilities or, alternatively, include other connections based on particular needs, specific circumstances, or proprietary technology. In the depicted example, device 12 includes a power cord 20, which could go to a simple wall outlet, to a battery, or to some other power source. Device 12 also includes a parallel port 22, a USB port 30, a drive's power chord 34, an integrated drive electronics (IDE) plug 36, and a small speaker 40, which can notify an end user when device 12 is active, when device 12 has failed, the progress of device 12, or when device 12 has completed its assigned tasks. Device 12 could also include a serial ATA (SATA) chord 26 and other suitable interfaces (e.g., FireWire, parallel ATA (PATA), etc.) as is needed.

FireWire is described in IEEE-1394 and it is a complex serial bus protocol. Parallel ATA (PATA) has been the industry standard for connecting hard drives and other devices in computers. However, due to a few major limitations, PATA is being uniformly replaced by SATA. To compare, PATA cables are limited in length and are large and bulky, which can restrict airflow. More complex computing devices continue to generate more heat and this can cause many problems including complete computer failure when using PATA. In addition, there is an important difference in the maximum bandwidth between the two technologies. The true maximum transfer rate of PATA is 100 MB/sec with bursts up to 133 MB/sec. With the first introduction of SATA, the maximum transfer rate was 150 MB/sec, which then grew to a maximum transfer of 300 MB/sec in 2005 and 600 MB/sec in 2008.

FIG. 3 is a simplified example block diagram of device 12, which is to be used for managing data. Each component of device 12 has complementary software in a laptop 46. Laptop 46 represents a computing device to be used by the forensic consultant (an authorized administrator of device 12) and, thus, could be any suitable devices (such as a desktop) that would facilitate the operations of the forensic expert.

In this example embodiment, device 12 and laptop 46 (respectively) may include a processor 50a and 50b, a memory 52a and 52b, and a preprogramming element 54a and 54b. Preprogramming element 54b in laptop 46 could simply include a stored version of the preprogramming instructions, or updates for this programming item.

Additionally, device 12 and laptop 46 (respectively) may include a wireless LAN/LAN connectivity element 56a and 56b, a controller application 58a and 58b, a targeted search engine 60a and 60b, a VPN connect element 64a and 64b, a logging element 68a and 68b, and a diagnostic element 70a and 70b. Device 12 also includes a PASS and FAIL signal 62 and 63 (which in this example are implemented using simple green and red lights). Note that this arrangement is comprehensive, as it has only been offered for purposes of illustration and teaching for the audience. Any given device 12 can include some or all of these features without departing from the spirit of the present invention.

From a macro-level, controller application 58b can be viewed as an authoritative element that allows an administrator the ability to perform various types of copying, searching, or any other function from a remote location. In other scenarios, controller applications 58a and 58b allow an administrator the ability to sit in a given space and control multiple devices 12 simultaneously. For example, if there were forty target machines that needed to be imaged, the administrator could plug in each device 12 and then sit at some type of home station and trigger and/or manage each device 12 from that location. Thus, it would not require ten data collection employees to image forty target machines. In this scenario, a single person could image forty machines or perhaps a team of three employees could accomplish this task.

Note that the data-acquisition aspect of these activities is just a small part of the data collection business model. There are more significant data-manipulation activities that involve processing the data, producing the data to interested parties, culling through the data for specific inquiries, segmenting the data into identifiable groups, etc. Thus, in using device 12 the initial cumbersome task of acquiring data is effectively minimized. By leveraging device 12, the forensic expert can immediately move toward more financially rewarding activities, while not being bogged down with the tedious initial imaging of hard-drives.

In regards to the installable software controller application 58a and 58b, the application can easily launch on device 12 and laptop 46 when they are connected to a wireless LAN and/or a LAN. The application will allow laptop 46 to control any number of devices at the same time. In one example, the controlling software will allow multiple source disk images to be copied to a single destination drive. While running, the software can show a list of devices connected to the LAN. The controlling application software can display if a destination drive has a file system available for writing data. If not, the software can prompt the user to format the destination drive (e.g., to FAT32). Furthermore, the controlling software can indicate when formatting is complete for a particular destination drive.

Controller application 58a and/or 58b can display the source drive's information including a serial number. Either software or hardware resident in either laptop 46 or device 12 will ensure that there is enough space on the destination drive to handle the contents of the source drive. If the controlling application detects an existing directory on the destination drive (from a previous copy function), the software can alert the user of this and allow the user to change the directory name for the pending disk copy (i.e., does not change or overwrite the existing directory or contents). The controller application will also let an end user input a directory name for a destination drive folder. As detailed herein, the controller application will allow an end user to select chunk size (e.g., default is 2 GB) and allow the end user to select a hash approach/type. [Note that device 12 is fully compatible with SHA1 and MD5 hashing protocols.] Other options for the controller application could include the absence of hashing, or specifying each chunk only, total drive only, chunks of data and a drive combined, etc.

VPN connect elements 64a and 64b offer a web-enabled over-VPN connect capability for even more remote control of the units (i.e., devices 12). Software will allow an end-user to initiate the copy process for connected units in any order and, furthermore, provide a copy status for each unit during the copy process. Messages may be displayed on a minimized LCD to inform the end user of the status (e.g., GB per-minute, approximate time remaining to complete, etc.).

It should also be noted that the internal structure and inherent functions of device 12 and laptop 46 are malleable and can be readily changed, modified, rearranged, or reconfigured in order to achieve their intended operations, as they pertain to the imaging functions outlined herein in this document. Software and/or hardware may reside in either of these elements [or both] in order to achieve the teachings of the enhanced imaging features of the present invention. However, due to their flexibility, these elements may alternatively be equipped with (or include) any suitable component, device, application specific integrated circuit (ASIC), processor, microprocessor, algorithm, read-only memory (ROM) element, random access memory (RAM) element, any type of SRAM or flash memory, erasable programmable ROM (EPROM), electrically erasable programmable ROM (EEPROM), field-programmable gate array (FPGA), or any other suitable element or object that is operable to facilitate the operations thereof. Considerable flexibility is provided by the structures of device 12 and laptop 46 in the context of system 10 and, accordingly, they should be construed as such.

In regards to the instructions for device 12 when utilizing preprogramming element 54a, one set of example instructions could include: 1) verification of a connection to a target hard-drive; 2) verification of a suitable destination device to which the target hard-drive will be copied; and 3) proceed to imaging the target hard-drive based on the unique requirements for this particular job. Note that the first two steps of this example process could include the validation of serial numbers in an effort to assure accuracy in data transitioning. Thus, the instructions could specify which drive is to be imaged and the type of cloning that will occur. Other preprogramming options could include more specific imaging (in contrast to cloning the entire hard-drive), compression options, formatting, checksums and validation options, or any other suitable parameter of interest to the administrator or the client.

It should be appreciated that there are valid reasons why an entire hard-drive should not be imaged in every instance. For example, in many litigation scenarios, there is sensitive information on the hard-drive. Thus, ‘targeted collections’ are employed to capture only the necessary data, while maintaining confidentiality for the client's other files. In certain scenarios, the targeted collection could involve a specific file type (Word Documents, PDFs, Excel Documents, TIFFs, etc.) or the targeted collection could involve a certain chronological timeline (e.g., capturing documents edited or created during a timeframe, capturing documents before or after a specific date, etc.). Other targeted searches could involve subject matter categories, or specific word searches. This feature set is a significant advancement over existing protocols in which a consultant would have to image the entire hard-drive and then manually filter out the undesired information.

In still other scenarios, a more intelligent searching feature is provided by device 12 through targeted search engine 60a. Often times, confidentiality parameters limit how a forensic expert is allowed to gather information. Consider an example in which the forensic expert is being asked to serve as a “Neutral Expert” and only harvest documents that include the following words: ‘options’ ‘strike price’ and the name ‘Doug Palkendo.’ Currently, no device would allow for the expert to intelligently collect this information. Instead, the forensic expert would be forced to image the entire hard-drive, create a group of search terms, selectively find and extract documents that meet the search criteria, and then delete the other information that did not meet these criteria. Device 12 would eliminate much of this overhead in offering a more linear approach. Device 12 could be instructed to collect the proper data from the outset, when the forensic expert is first given access to the hard-drive.

Yet another aspect of device 12 involves a set of encryption elements 57a and 57b. Industry standards currently require two copies of a hard-drive to be made. The first copy (once the hard-drive is replicated at the work site) normally gets shipped back to the home location of the consultant. The second copy is typically kept with the consultant at all times. The first copy is vulnerable to misuse, should it not reach its intended destination. Essentially, the first copy has a wealth of proprietary information that can be easily read by virtually anyone with a minimum of effort. To address this issue, device 12 includes the ability to encrypt information as it is being gathered. In one sense, device 12 has the ability to encrypt data sets as they are being imaged such that even if the cloned information is mishandled or ends up in the hands of someone who is unauthorized to view this information, the data is not vulnerable to unauthorized disclosure.

Logging elements 68a and 68b will document the imaging activities being performed by device 12 and, furthermore, any other activities associated with system 10 that may be of interest to an end user or an administrator. Logging elements 68a and 68b can systematically write a log file to the destination drive with the date and time data was written and, optionally, the MD5 hash value of the drive. Diagnostic elements 70a and 70b provide increased precision and less errors in the processing operations of device 12. In operation of an example process flow, when device 12 is connected to a target disk drive and a LAN, upon power up, device 12 can run a connection diagnostic that will result in a green LED if pass, and a red LED if the imaging failed in some manner.

In certain other examples of the present invention, the imaging process is verified by using the SHA-1 message digest algorithm (with a program such as shalsum) or other available algorithms such as MD5. At critical points throughout the analysis, the media is verified again, known as “hashing”, to ensure that the evidence is still in its original state. In corporate environments seeking civil or internal charges, such steps are generally overlooked due to the time required to perform them. However, they are essential for evidence that is to be presented in a court room and device 12 is certainly able to meet this need.

FIGS. 4A-4C are simplified schematic diagrams that illustrate device 12 operating in the first and third modes (the preprogrammed protocol and the VPN protocol). Turning first to FIG. 4A, if device 12 is sent out to a given client, there are two viable options for achieving the imaging. The first option is a preprogramming mode in which the administrator of device 12 has included software in device 12 to direct device 12 in its operations. The important advantage in this first option is that network connectivity is not necessarily a requirement.

Consider an example in which important data is residing in a remote location that has no reliable network connection. This preprogramming option would allow the forensic expert to simply deploy device 12 using the conventional mail system (e.g. the US Postal system, UPS, FedEx, etc.) at stage 74. The receiver of device 12 could simply open the box, plug device 12 into some type of power outlet, and initiate the imaging process via a set of instructions as outlined herein in this document. This is reflected at stage 76.

Thus, device 12 has the ability to be preprogrammed with copy parameters (directory name and chunk size) so that it just needs to be plugged into the appropriate drives and started. Device 12 can have a default disk copy routine that can be run if there is no LAN or controlling PC available. Additionally, device 12 would create a default name for the disk that could be edited at a later time. In one example embodiment, device 12 uses a flash RAM that includes a simple program that guides device 12 in its operations. Other types of memory can certainly be used and it should be appreciated that any such memory types are clearly within the broad scope of the present invention.

Note that this program [for the preprogrammed model] can certainly be updated (or updates can be sent out to devices 12 over a network) to change or modify the behavior of devices 12. Additionally, from a business perspective, devices 12 can include a single ‘user-license’ or the software described herein could have the same controlling usage capability. In other scenarios, a subscription model could be used such that each device 12 would have a specific time period of operation (e.g. annual, monthly, etc.). In such instances, a simple network connection could be used to validate the terms of use when device 12 is activated or used. In still other scenarios, the software that is resident in the forensic expert's computing device (e.g., his laptop) could authorize the exact number of devices 12 that he is legally permitted to control. For example, a single end-user license would grant the right to control a single unit (and not a pool of units). In one example implementation, a typical customer (seeking to enjoy the benefits of the present invention) would purchase the hardware (device 12), the software (the controlling software for a laptop or similar computing device), and an annual maintenance fee, which would disable the software at the end of a given term.

Returning now to stage 80 of FIG. 4A, at this juncture, the client simply returns device 12 to the forensic expert using any suitable shipping method. Finally, at step 82, the forensic expert receives the captured data and he can now perform an unlimited series of operations with this harvested information.

FIG. 4B is illustrating the third option (VPN/Enterprise protocol), where network connectivity is offered at the target location. Thus, device 12 can be sent out to a given client, where the client can simply plug in the machine, achieve some type of network connectivity, and have the cloning or imaging process initiated. Note that while operating in this Enterprise Mode, device 12 can still accomplish all the tasks as outlined in FIG. 3, but it can also facilitate network features that give a consultant a proverbial platform from which the consultant can perform any number of selected tasks. For example, consider a case where device 12 is mailed to Chicago in stage 74 (as depicted in FIG. 4B). At stage 78, a representative of the company (who owns the hard-drive) receives device 12, powers up device 12, and connects it to a targeted hard-drive. Once connected and powered UP, device 12 begins searching for a LAN, WAN, MAN, Wi-Fi access point, hot-spot, Edge Network, or WLAN and makes a viable connection to the network. Device 12 also understands that it must immediately notify its administrator of its whereabouts and its operational status.

Thus, once powered ON, device 12 has embedded software that is immediately activated and that seeks to establish a communication to a controller element that is controlled by a forensic expert at another location. The administrator (through software residing in device 12 and through software at the administrator's home location) can interface with device 12. In this sense, the administrator is accomplishing the same work, as if he were out at the work site, but without having to be physically present at the site. The forensic expert could now perform any task he wishes with this important VPN capability. For example, the forensic expert could run searches, create images, pull reports, perform targeted collections, browse the targeted hard-drive, etc. Note that all such operations will preserve the integrity of the data and, furthermore, be able to produce an electronic chain of custody if required to do so.

FIG. 4C is a simplified process flow that depicts how a given client can be better guided through the imaging process. This illustration is depicting the situation somewhere between a fully preprogrammed mode (which is almost completely autonomous) and a VPN mode, in which the forensic expert is controlling virtually all activities of device 12. The process flow begins at step 74 once again, where the forensic expert ships the device to the client site. At step 79, the company's representative opens the package, plugs device 12 into a suitable power source, and is then guided through a series of steps that accomplish his data imaging needs. For example, a series of questions could be provided that identify the client's needs in imaging this information.

One prompt could query: ‘Would you like to perform a targeted search for images’ The follow-up question could be: “Would you like to search based on date, file size, file type, etc.” In situations where there is sensitive or confidential information, the client is empowered to circumnavigate this information in only collecting specific types of information. All of the parameters outlined herein in this document can serve as a viable basis for questions being proffered to the client in this instance. Note that the forensic expert can certainly offer some consulting (e.g., via the telephone or through e-mail) as the client navigates through a series of questions, or through a menu system of device 12. Once device 12 completes all its activities, then the client would ship device 12 back to the forensic expert at step 80. At step 82, the forensic expert would receive the harvested information and then he could process or manage the data according the client's wishes.

FIGS. 5A-5B are simplified flow diagrams illustrating a local network protocol (the second protocol or the second option) for device 12. In this example scenario, at stage 84 of FIG. 5A, a forensic consultant hooks up three devices 12 to three computers of a pool of fifteen computers. In this scenario, which is the most commonly occurring scenario, only one or two consultants would be needed to manage this data collection. In this specific illustrated example, a single consultant would trigger the data imaging for each targeted hard-drive. The consultant could monitor each hard-drive collection through his laptop. As one hard-drive collection completes, one of devices 12 is moved to a next targeted hard-drive location.

Note that such operations would conventionally be accomplished by physically standing in front of each targeted machine as they are being copied. In essence, the targeted machine is taken apart, the imaging process is initiated, and after the process has been completed, the targeted machine is put back together and then a subsequent process is initiated for the next targeted machine. Also, the three devices 12 that are brought onto the job site would merit three individual workspaces having to be managed by the consultant.

It should be appreciated that each time a new process has begun, the copying parameters for that particular task need to be input into device 12. This increases the copying time and, furthermore, necessitates more consultant oversight before a subsequent collection can occur. Device 12 and the consultant's laptop include software that offers a template, which can be activated for a given type of project. For example, in this scenario of FIGS. 5A and 5B, the template for ABC Company can be triggered for each subsequent data imaging task. Thus, a single consultant could theoretically control a group of devices 12 from the next room (or from across the country) with simple software that minimizes the data-collection process at each step. In this instance, only the template would have to be launched and the consultant's role is significantly reduced.

At stage 86 of FIG. 5B, the consultant unhooks the three devices 12 and moves them to another set of three computers in the pool. After this is done, he has nine target devices (i.e., hard-drives) remaining to image. Note that each device 12 is controlled independently by the consultant. Data imaging is being accomplished in parallel so deficiencies in one data collection (or system failures in one imaging scenario) are insulated from other imaging activities.

It is critical to note that the stages and steps in FIGS. 4A-5B illustrate only some of the possible scenarios and operations that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within system 10 to effectuate the tasks and operations of the elements and activities associated with executing imaging transactions.

Although the present invention has been described in detail with reference to particular embodiments, it should be understood that various other changes, substitutions, and alterations may be made hereto without departing from the spirit and scope of the present invention. The illustrated device architectures of FIGS. 1-3 has only been offered for purposes of example and teaching. Suitable alternatives and substitutions are envisioned and contemplated by the present invention: such alternatives and substitutions being clearly within the broad scope of system 10.

Numerous other changes, substitutions, variations, alterations, and modifications may be ascertained to one skilled in the art and it is intended that the present invention encompass all such changes, substitutions, variations, alterations, and modifications as falling within the spirit and scope of the appended claims.

What is claimed is:

1. An imaging system, comprising:
an imaging device operable to image a hard-drive of a target device, wherein the imaging device includes a first connection to the target device and a second connection to an output capture device, whereby both connections facilitate an information flow of data, and wherein the imaging device includes a network connectivity element that allows the imaging device to be connected to a network, the network connection facilitating communications between a computing device being controlled by an administrator and the imaging device such that that administrator controls some operations of the imaging device from his computing device.

2. The imaging system of claim 1, wherein the imaging device includes a targeted search engine that allows the imaging device to perform targeted searches on the hard-drive.

3. The imaging system of claim 1, wherein the imaging device encrypts data as it captures it.

4. The imaging system of claim 1, wherein the imaging device includes a diagnostic element that performs an error check for operations performed by the imaging device.

5. The imaging system of claim 1, wherein the imaging device includes a processor that executes hashing operations for data being collected by the imaging device.

6. The imaging system of claim 1, wherein the network is a selected one of a group of networks, the group consisting of:
a) LAN;
b) Wi-Fi network;
c) WLAN;
d) WAN;
e) MAN;
f) an Edge Network; and
g) a hot spot.

7. The imaging system of claim 1, wherein the imaging device includes a VPN connect element that offers a web-enabled over-VPN connect capability to control the imaging device by the administrator.

8. The imaging system of claim 7, wherein when in a VPN mode, the administrator can perform a selected one of running searches, creating images, generating reports, performing targeted collections, and browsing the hard-drive.

9. The imaging system of claim 1, wherein the imaging device includes software that tracks a copy status for the hard-drive during imaging operations for the hard-drive.

10. The imaging system of claim 1, wherein the imaging device includes a light and a speaker, and wherein a selected one or both of the light and the speaker indicate some form of status for the imaging device.

11. Software for assisting in imaging of data, the software comprising computer code that resides in memory, the code being executed by a processor and operable to:
provide network connectivity for an imaging device operable to image a hard-drive of a target device, wherein the imaging device includes a first connection to the target device and a second connection to an output capture device, whereby both connections facilitate an information flow of data; and
provide a controller application, wherein the network connection facilitates communications between a computing device being controlled by an administrator and the imaging device such that that administrator controls some operations of the imaging device from his computing device through the controller application.

12. The code of claim 11, wherein the code is further operable to perform targeted searches on the hard-drive.

13. The code of claim 11, wherein the code is further operable to generate a log of activities performed by the imaging device.

14. The code of claim 11, wherein the code is further operable to perform an error check for operations performed by the imaging device.

15. The code of claim 11, wherein the code is further operable to execute hashing operations for data being collected by the imaging device.

16. The code of claim 11, wherein the imaging device and the computing device include software that complements activities executed by the other.

17. The code of claim 11, wherein the code is further operable to offer a web-enabled over-VPN connect capability to control the imaging device by the administrator.

18. The code of claim 17, wherein when in a VPN mode, the administrator can perform a selected one of running searches, creating images, generating reports, performing targeted collections, and browsing the hard-drive.

19. The code of claim 11, wherein the code is further operable to track a copy status for the hard-drive during imaging operations for the hard-drive.

20. The code of claim 11, wherein the imaging device includes a light and a speaker, and wherein a selected one or both of the light and the speaker indicate some form of status for the imaging device.
